(19) United States
(12) Patent Application Publication
(10) Pub. No.: US 2018/0191180 A1
(43) Pub. Date: Jul. 5, 2018

(54) SYSTEMS AND METHODS FOR PORTABLE CHARGING SYSTEMS AND DESIGNS THEREOF

(71) Applicant: Ahkeo Labs, LLC, Mayfield Village, OH (US)

(72) Inventor: Brent M. Skoda, Irving, TX (US)

(73) Assignee: Ahkeo Labs, LLC, Mayfield Village, OH (US)

(21) Appl. No.: 15/397,707

(22) Filed: Jan. 3, 2017

(51) Int. Cl. H02J 7/00

(52) U.S. Cl. CPC H02J 7/0042

(57) ABSTRACT

A portable charging system comprises a central member including an electrical charge generating component and a plurality of communication ports and a plurality of peripheral members having a proximal end extending from the central member. Each of the plurality of peripheral members includes a communications interface configured to be inserted within a corresponding communications port of a computing device or a peripheral of a computing device. A first peripheral member of the plurality of peripheral members includes a USB port and a second peripheral member of the plurality of peripheral members includes a smartphone connector. The first peripheral member and the second peripheral member are communicatively and electrically coupled. The plurality of peripheral members includes a third peripheral member including an audio jack, the audio jack communicatively coupled to a computing device that is configured to be connected to the first peripheral member or the second peripheral member.

### TECHNICAL FIELD

The present disclosure relates to portable charging systems and devices, and more particularly to systems and methods for a charging and data transmission system configured to connect devices to one another.

### BACKGROUND

The massive adoption of portable consumer electronic devices has significantly increased the need for portable charging systems. These portable charging systems may include a battery or other energy storage element to store electrical charge.

### SUMMARY

According to an aspect of the present disclosure, a portable charging system, including a central member including an electrical charge generating component and a plurality of communication ports and a plurality of peripheral members having a proximal end extending from the central member. Each of the plurality of peripheral members includes a communications interface configured to be inserted within a corresponding communications port of a computing device or a peripheral of a computing device. A first peripheral member of the plurality of peripheral members includes a USB port and a second peripheral member of the plurality of peripheral members includes a smartphone connector. The first peripheral member and the second peripheral member are communicatively and electrically coupled. In some implementations, the plurality of peripheral members includes a third peripheral member including an audio jack, the audio jack communicatively coupled to a computing device that is configured to be connected to the first peripheral member or the second peripheral member.

### BRIEF DESCRIPTION OF THE DRAWINGS

FIG. 1 illustrates a perspective view of a portable data communications and charging system according to an embodiment of the present disclosure.

FIG. 2 illustrates a perspective view of a smart phone protective case with integrated communications ports according to an embodiment of the present disclosure.

FIG. 3 illustrates a rear perspective view of the smart phone case shown in FIG. 2 according to an embodiment of the present disclosure.

FIG. 4 illustrates an exploded view of a smart phone, smart phone case, and communications cables according to an embodiment of the present disclosure.

FIG. 5 illustrates a top view of a retractable communications cable with a electricity generating component according to an embodiment of the present disclosure.

FIGS. 6A and 6B illustrate front perspective and rear perspective views of an integrated communications hub and energy generation and storage device according to an embodiment of the present disclosure.

FIG. 7 illustrates an inside view of the integrated communications hub and energy generation and storage device shown in FIGS. 6A and 6B according to an embodiment of the present disclosure.

FIGS. 8A-8G illustrates perspective views of various components of an integrated communications hub and energy generation and storage device according to an embodiment of the present disclosure.

FIGS. 9A-11 illustrate embodiments of a vaping device according to an embodiment of the present disclosure.

FIG. 12A illustrates a perspective view of a packaging for a vaping device shown in FIG. 12B according to an embodiment of the present disclosure.

FIG. 12B illustrates a vaping device according to an embodiment of the present disclosure.

FIG. 12C illustrates a smart phone executing a smart phone application configured to control the vaping device shown in FIG. 12B according to an embodiment of the present disclosure.

FIGS. 13A-14D illustrate various screenshots of a smart phone executing a smart phone application configured to control the vaping device shown in FIG. 12B according to an embodiment of the present disclosure.

FIG. 15 illustrates a perspective view of a vaping device according to an embodiment of the present disclosure.

FIG. 16 illustrates a perspective view of a vaping device according to an embodiment of the present disclosure.

FIG. 17 illustrates a vaping device according to an embodiment of the present disclosure.

FIG. 18 illustrates a perspective view of a vaping device with different types of cartridges according to an embodiment of the present disclosure.

FIG. 19 illustrates a perspective view of an energy generating cartridge for the vaping device shown in FIG. 18 according to an embodiment of the present disclosure.

FIGS. 20A and 20B illustrate perspective views of a cartridge that can heat herbs for use in the vaping device shown in FIG. 18 according to an embodiment of the present disclosure.

FIGS. 21A and 21B illustrate perspective views of cartridges that can heat oils or other liquids for use in the vaping device shown in FIG. 18 according to an embodiment of the present disclosure.

FIGS. 22A-22E illustrate various views of an exercise bicycle according to an embodiment of the present disclosure.

FIGS. 23A-23E illustrate various views of an exercise bicycle according to another embodiment of the present disclosure.

The features and advantages of the present solution will become more apparent from the detailed description set forth below when taken in conjunction with the drawings, in which like reference characters identify corresponding elements throughout. In the drawings, like reference numbers generally indicate like elements.

### DETAILED DESCRIPTION

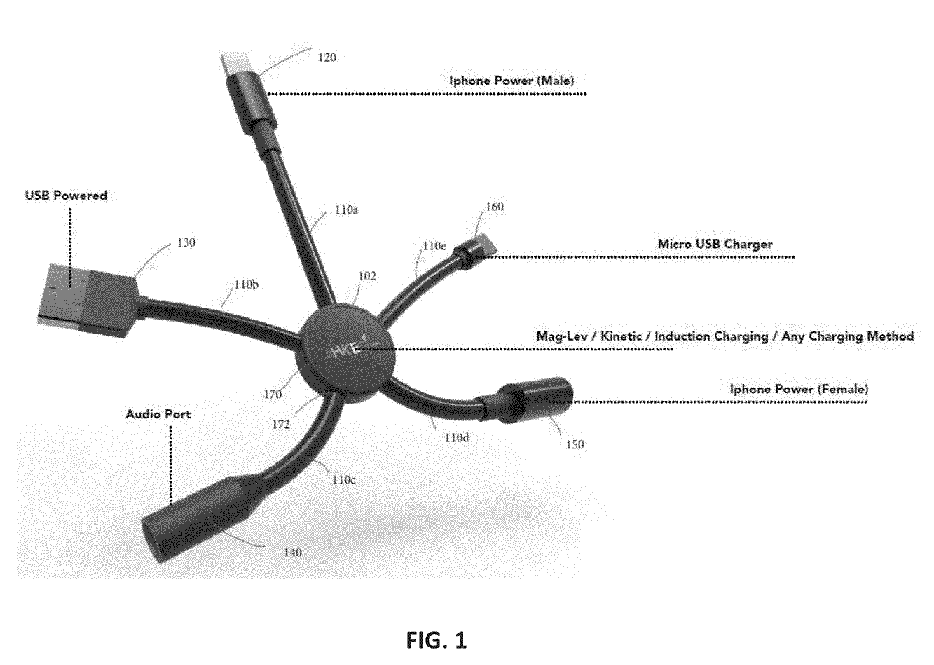

The present disclosure relates to a charging and data transmission system configured to connect devices to one another. FIG. 1 shows a modular charger 100. The modular charger 100 can include a central member 102 and a plurality of peripheral members 110a-n extending from the central member 102. In some implementations, the central member 102 can include components that enable magnetic levitation. In some implementations, the central member 102 can include components that enable induction charging. In some implementations, the central member 102 can include components that enable kinetic charging.

In some implementations, one or more of the peripheral members 110 can be electrically coupled or communicatively coupled to the central member 102. The peripheral members 110 can include electrical wires for transmitting current and/or data between a port coupled to the peripheral member and the central component. In some implementations, one or more of the peripheral members 110 can include one or more ports. In some implementations, one or more of the ports can be a communications port. In some implementations, one or more of the ports can be a power transmissions port. In some implementations, one or more of the ports can be a power receiving port. As shown in FIG. 1, a first peripheral member 110a is coupled to a lightning connector 120, such as a lightning connector configured to be inserted into a port of devices manufactured by APPLE, headquartered in Cupertino, Calif. A second peripheral member 110b is coupled to a USB connector 130. A third peripheral member 110c is coupled to an audio port 140 (such as a 35 mm audio jack or a 35 mm female port). A fourth peripheral member 110d is coupled to a lightning connector port 150 configured to receive a lightning connector, such as the lightning connector 112. A fifth peripheral member 110n is coupled to a micro USB connector 160. In some implementations, the central member 102 can be coupled to any number of peripheral members 110.

In some implementations, the central member can be coupled to additional peripheral members that may be coupled or otherwise attached to a USB port to receive a USB connector. In some implementations, the central member can be coupled to a port to receive one or more of a micro USB connector, a 30 pin connector, a 30 pin connector, among others.

In some implementations, the central member 102 can be coupled to a Bluetooth transceiver via the peripheral member. In some implementations, the central component can include a Bluetooth transceiver. In some implementations, the central member can include a wireless network interface card that can be powered through one of the charging ports coupled to the central member. In some implementations, the modular charger can include wireless communication interfaces, such as WiFi, bluetooth, etc., which could act as a booster for communication protocols and would allow data to be transferred between a computing device coupled to the modular charger via one of the peripheral members and another computing device wirelessly coupled to the modular charger.

In some implementations, the modular charger can include one or more attachment mechanisms through which a user may choose to attach the modular charger for carrying. For instance, the modular charger can be coupled to a keychain to attach the modular charger to a keychain holder. In some implementations, the modular charger can include an adhesive surface for removably attaching the charger to a surface.

In some implementations, the modular charger can include components to enable power generation. For instance, the modular charger can include components that can generate, store or transfer power using external environmental conditions, such as wind, precipitation, solar, among others. In some implementations, the modular charger can include components that can generate, store or transfer power using kinetic energy due to motion. In some implementations, the modular charger can include components that can generate, store or transfer power using potential energy. In some implementations, the modular charger can include a battery or energy storage component. In some implementations, the form factor of the energy storage component can be such that it fits within the central component.

In some implementations, the modular charger can be used to connect multiple devices to one another. In some implementations, the modular charger can be used to transfer power from one device to another device. In some implementations, the modular charger can be used to transfer data from one device to another device.

In some implementations, the peripheral members can be made from a flexible material. In some implementations, the central component 102 can include a housing 170 that includes openings 172 through which wires coupled to the central component 102 can extend into the peripheral members 110 and couple to one of the ports coupled to the peripheral members 110. In some implementations, the openings can be spaced apart. In some implementations, the housing can be cylindrical and the openings can be defined in the radial wall of the housing. In some implementations, the peripheral members can be retractable. In some implementations, the peripheral members can be removably attached to the central component. In some implementations, one or more peripheral members can include a connector at a first end of the peripheral member that is configured to be coupled to a connector of the central component such that the peripheral members can be removably attached to the central component. Each connector of the central component can be configured specifically for a particular type of peripheral member. Each peripheral member can be a particular type based on the port (lightning connector, audio connector, USB connector, etc.) coupled to the peripheral member. In some implementations, on outer surface of the housing can include a logo for branding purposes.

### Any-Port Phone Case

Portable computing devices are often kept in cases to protect the device from damage. The present disclosure also describes a computing device case that includes a communications adapter configured to be connected to the computing device inserted within the computing device case. The communications adapter can be communicatively coupled to one or more additional ports configured on the device case such that a computing device that does not have specifically assigned ports can be configured with such ports.

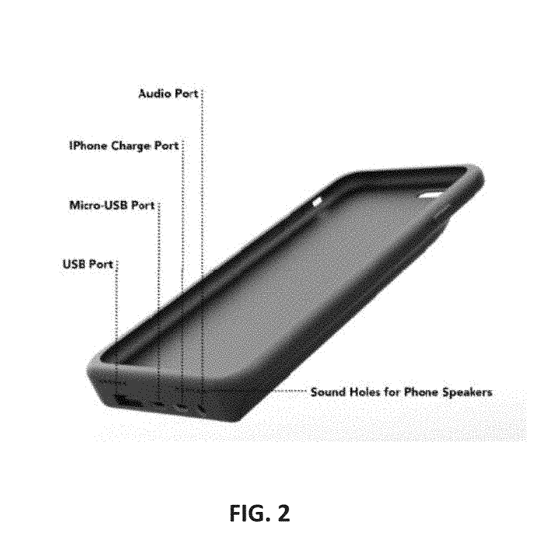

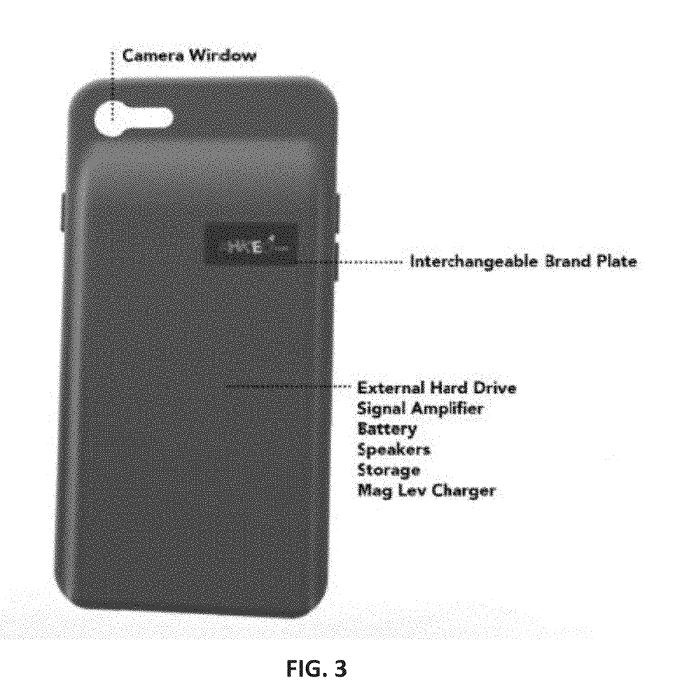

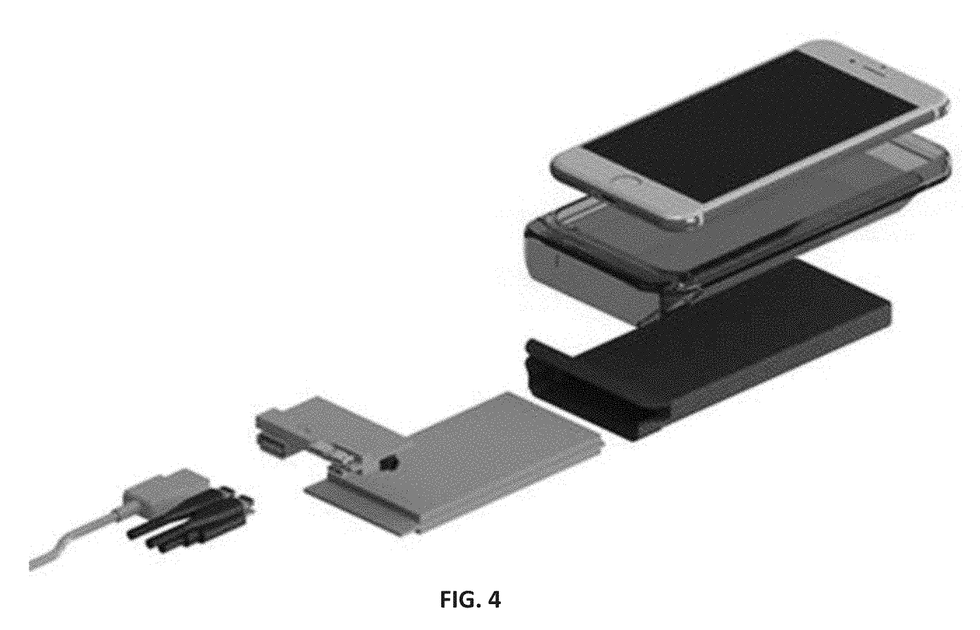

As shown in FIG. 2, the device case can be sized and shaped to encompass and securely retain a computing device, such as a mobile phone, for example, an APPLE IPHONE 7. The device case can be sized and shaped different depending on the computing device to which it corresponds. The computing device case can include a device connector configured to be inserted within a port of the computing device, such as the phone. The device connector can be electrically or communicatively coupled to a USB port, a micro USB port, a lightning connector (Iphone Charge Port), and an audio port. When the device connector is inserted into the phone's receiving port, the one or more additional ports of the case are activated and are communicatively coupled to the computing device. In some implementations, the case includes internal wiring between the device port of the case and the one or more ports.

The device case can include a camera window. The device case can include sound holes. The sound holes can be positioned in the case adjacent to where the speakers of the phone are such that the case does not block the sound from the speakers. In some implementations, the device case can include or define a sound channel to route sound from the device case to one or more speaker holes. The sound channel can be configured to amplify the sound of the speakers based on the shape and material of the device case. The device case can include one or more button objects configured to cause a button of the device to be pressed when the button object of the device case is pressed. The device case can include an external hard drive or can be configured to receive an external hard drive. The device case can include a signal amplifier or can be configured to receive a signal amplifier. Examples of signal amplifiers can include a cellular signal amplifier, a Bluetooth signal amplifier, a WIFI signal amplifier, among others. The case can include a battery or can be configured to receive a battery. The device case can include speakers or can be configured to receive speakers. In some implementations, the device case can include a space to store physical objects, such as keys, credit cards, money, or other physical objects. In some implementations, the case can include a magnetic levitation charging component or a induction-based charging component. In some implementations, the device case can have a magnetic portion to mount to magnetic holders or mounts, such as vehicle mounts. The device case can include an interchangeable brand plate.

In some implementations, one or more of the ports can be electrically coupled or communicatively coupled to the device connector. In some implementations, one or more of the ports can be a communications port. In some implementations, one or more of the ports can be a power transmissions port. In some implementations, one or more of the ports can be a power receiving port. In some implementations, the device connector can be coupled to additional ports, such as a male or female USB connector. In some implementations, the device connector can be coupled to a port to receive one or more of a micro USB connector, a 30 pin connector, a 30 pin connector, among others.

In some implementations, the central member 102 can be coupled to a Bluetooth transceiver via the peripheral member. In some implementations, the central component can include a Bluetooth transceiver. In some implementations, the central member can include a wireless network interface card that can be powered through one of the charging ports coupled to the central member. In some implementations, the modular charger can include wireless communication interfaces, such as WiFi, bluetooth, etc., which could act as a booster for communication protocols and would allow data to be transferred between a computing device coupled to the modular charger via one of the peripheral members and another computing device wirelessly coupled to the modular charger.

In some implementations, the device case can include one or more attachment mechanisms through which a user may choose to attach the modular charger for carrying. For instance, the device case can be coupled to a keychain to attach the device case to a keychain holder. In some implementations, the device case can include an adhesive surface for removably attaching the device case to a surface.

In some implementations, the device case can include components to enable power generation. For instance, the device case can include components that can generate, store or transfer power using external environmental conditions, such as wind, precipitation, solar, among others. In some implementations, the device case can include components that can generate, store or transfer power using kinetic energy due to motion. In some implementations, the device case can include components that can generate, store or transfer power using potential energy. In some implementations, the device case can include a battery or energy storage component. In some implementations, the form factor of the energy storage component can be such that it fits within the device case.

In some implementations, the device case can be used to connect multiple devices to one another. In some implementations, the device case can be used to transfer power from one device to another device. In some implementations, the device case can be used to transfer data from one device to another device.

### Orbit Pull Charger

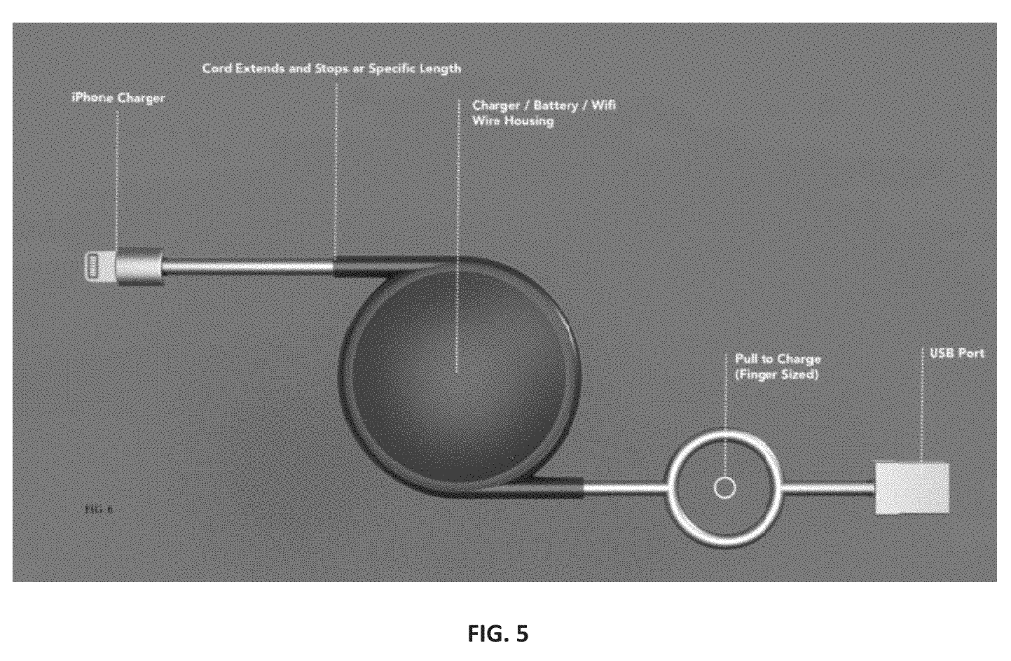

A device includes a battery, a charging port and a charging system that is configured to generate electrical charge that can be stored in the battery. The charge stored in the battery can be transferred to a computing device via the charging port. As shown in FIG. 5, the device includes a central component that can include a battery, one or more communication modules, such as WiFi, Bluetooth, etc. and a charging module. The charging module can be configured to generate electrical charge that can be stored in the battery.

The charging module can include a magnetic levitation charging module. The magnetic levitation charging module can generate a charge by pulling a retractable cord. The retractable cord can include a structure that facilitates or is sized to allow a user to pull the retractable cord. The retractable cord can cause the magnetic levitation charging module to generate a charge by applying a force via the retractable cord. The magnetic levitation charging module can include one or more magnets that levitate a ferrous component or other component that can be levitated by the magnets. As the retractable cord is pulled, a force is applied to the component or the magnets to cause a generation of an electrical charge. In some implementations, the electrical charge is generated by moving a rotor relative to a stator.

The charging module can include at least one rotor and at least one stator. The retractable cord can cause a rotor to rotate relative to the stator causing the generation of electrical charges, which can then be stored in the battery.

The retractable cord can cause an electrical charge to be generated and stored in the battery by repeatedly pulling the retractable cord away from the central component.

In some implementations, the device can include multiple retractable cords that can be coupled to multiple charging modules.

In some implementations, the retractable cord can include a USB port that is communicatively coupled to the charging port. In this way, a data and/or a power connection can be established between a first computing device to which the charging port is connected and a second computing device to which the USB port is connected. The charging module can also include a processor and memory.

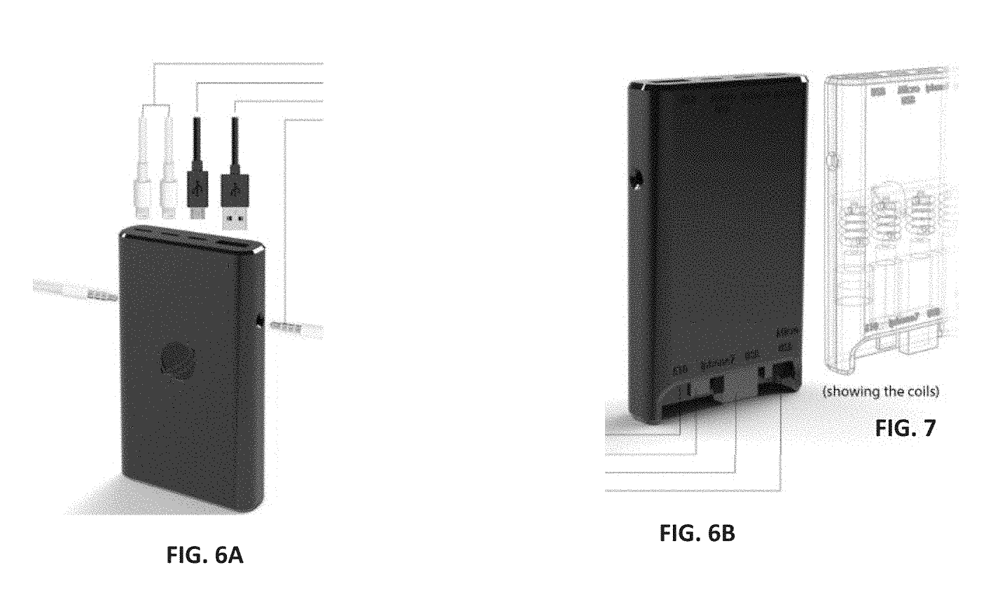

FIGS. 6A and 6B illustrate front perspective and rear perspective views of an integrated communications hub and energy generation and storage device according to an embodiment of the present disclosure.

FIG. 7 illustrates an inside view of the integrated communications hub and energy generation and storage device shown in FIGS. 6A and 6B according to an embodiment of the present disclosure.

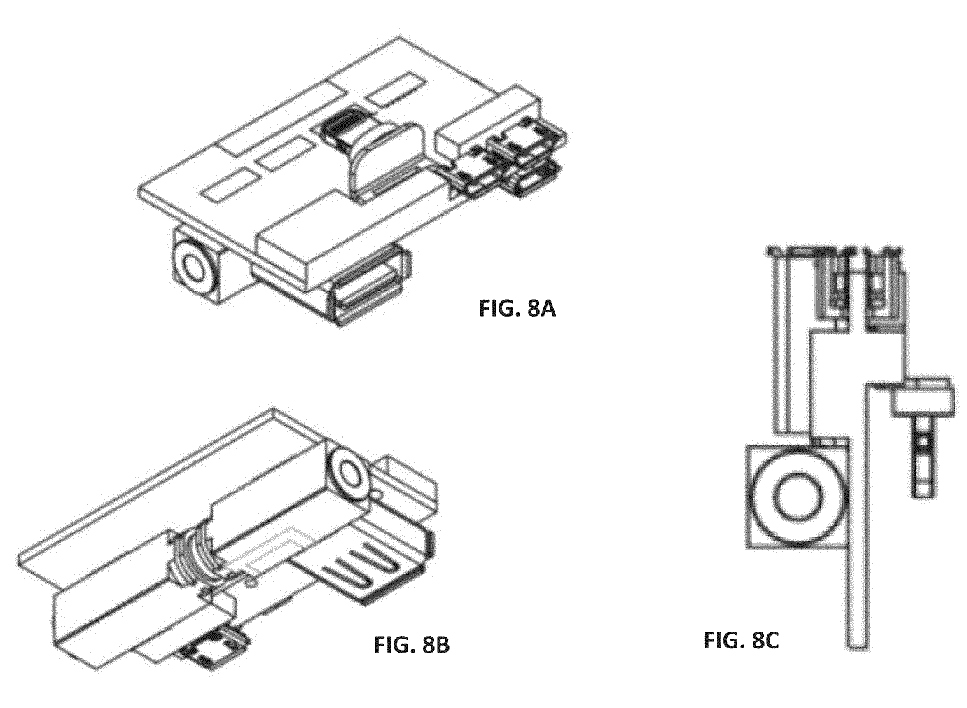

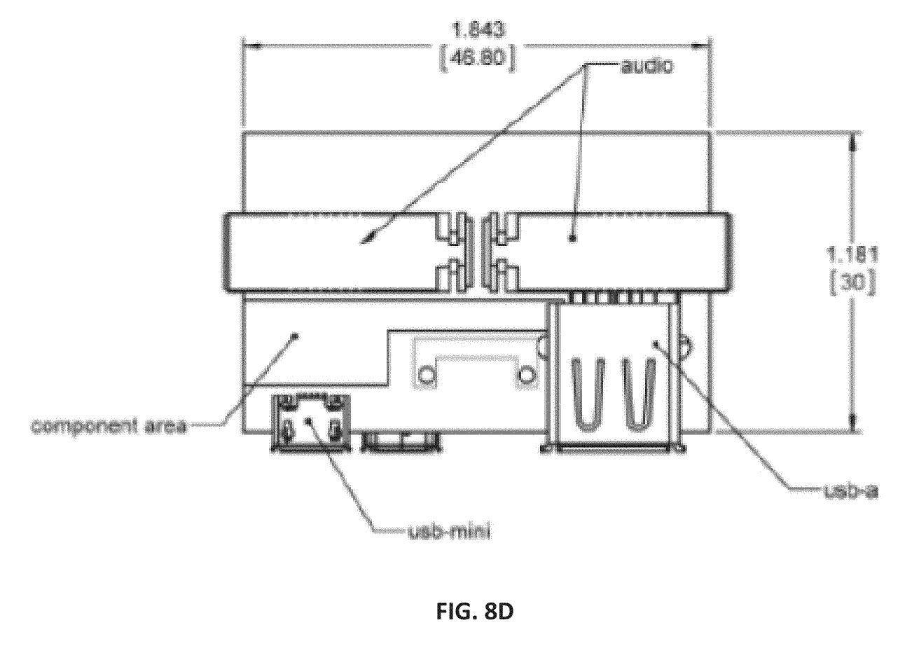

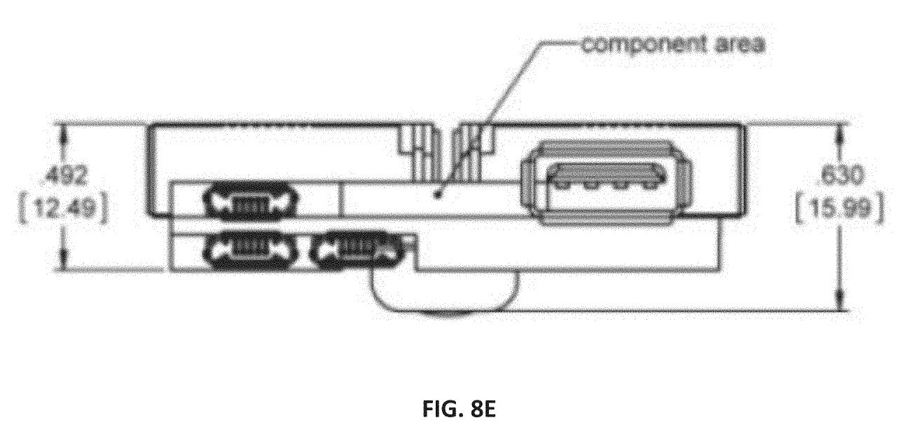

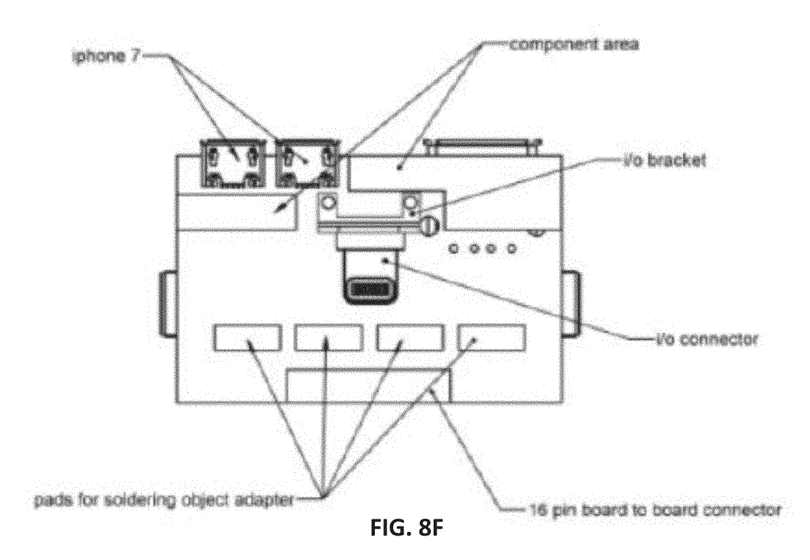

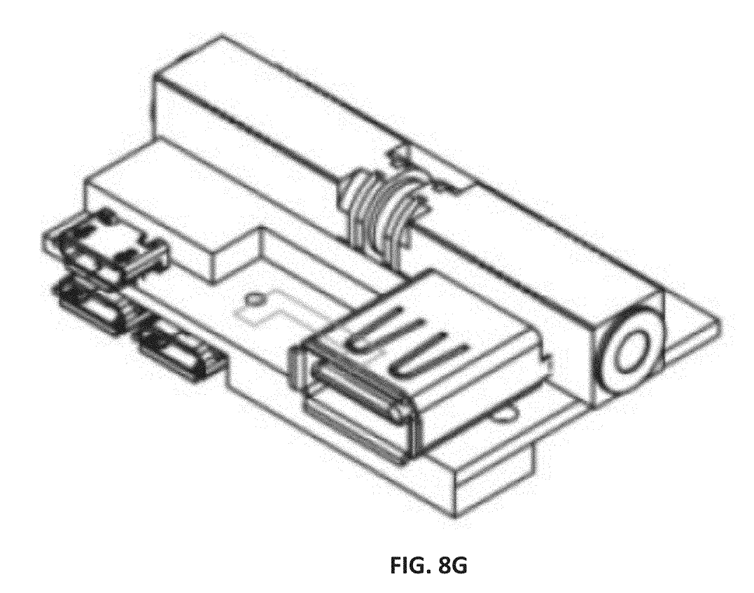

FIGS. 8A-8G illustrates perspective views of various components of an integrated communications hub and energy generation and storage device according to an embodiment of the present disclosure.

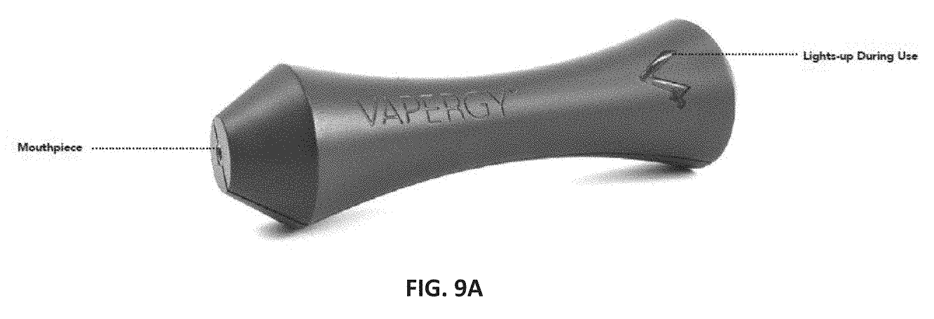

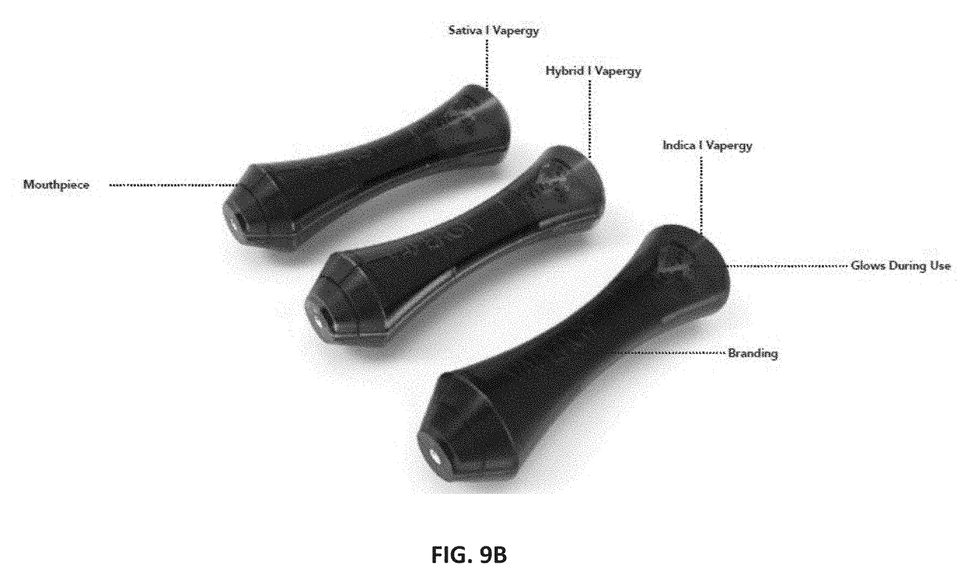

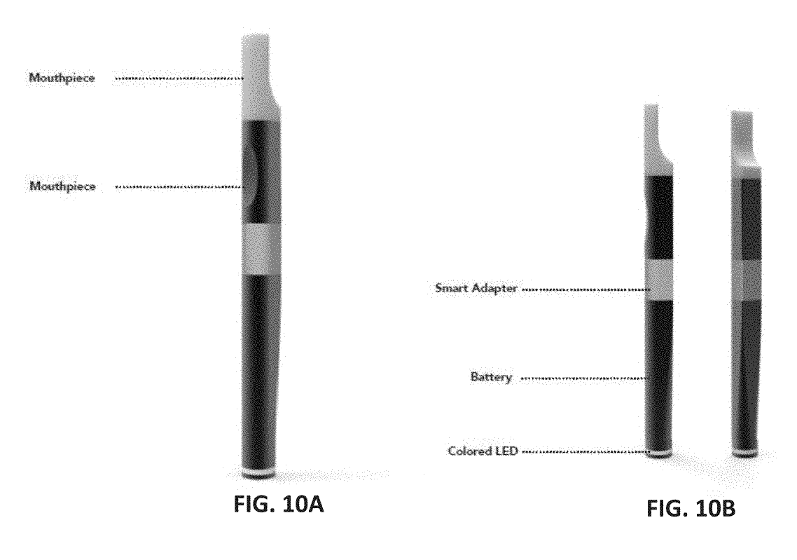

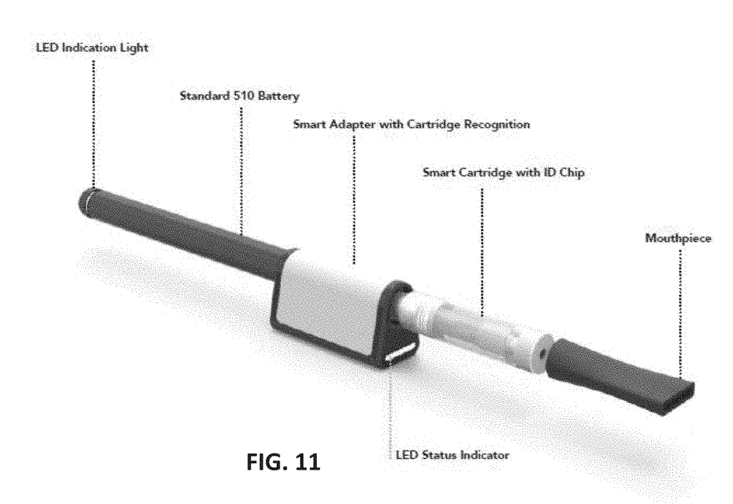

FIGS. 9A-11 illustrate embodiments of a vaping device according to an embodiment of the present disclosure.

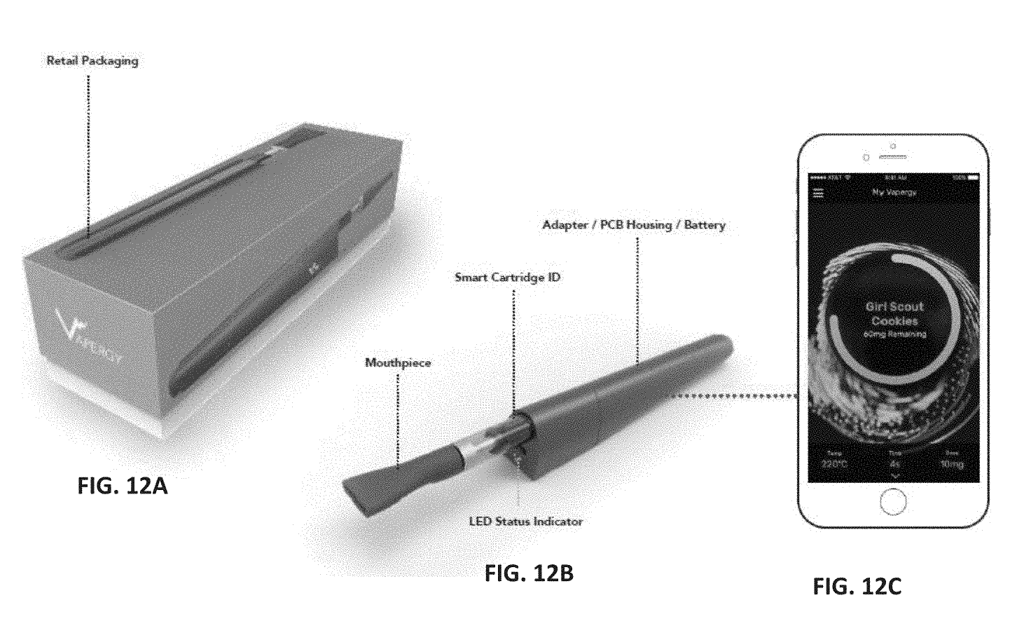

FIG. 12A illustrates a perspective view of a packaging for a vaping device shown in FIG. 12B according to an embodiment of the present disclosure.

FIG. 12B illustrates a vaping device according to an embodiment of the present disclosure.

FIG. 12C illustrates a smart phone executing a smart phone application configured to control the vaping device shown in FIG. 12B according to an embodiment of the present disclosure.

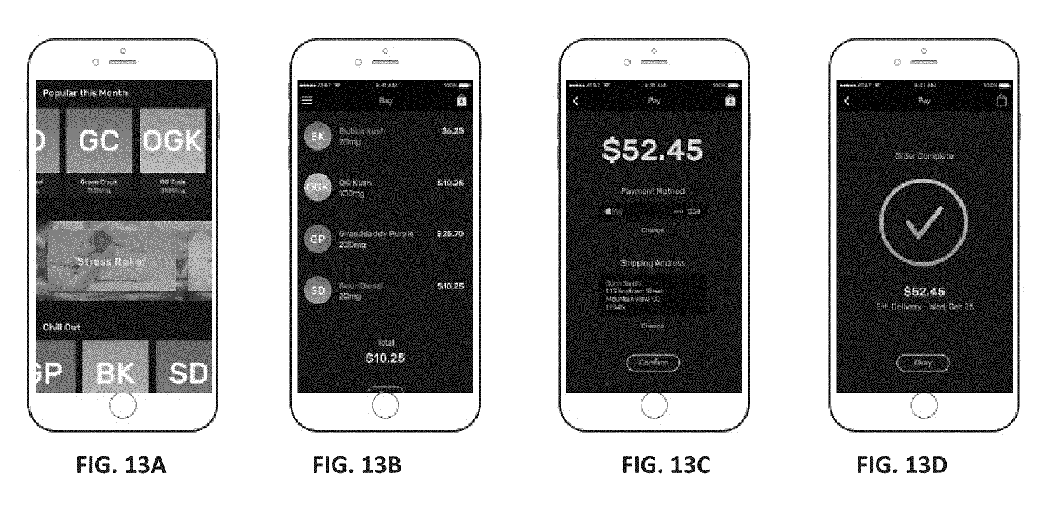

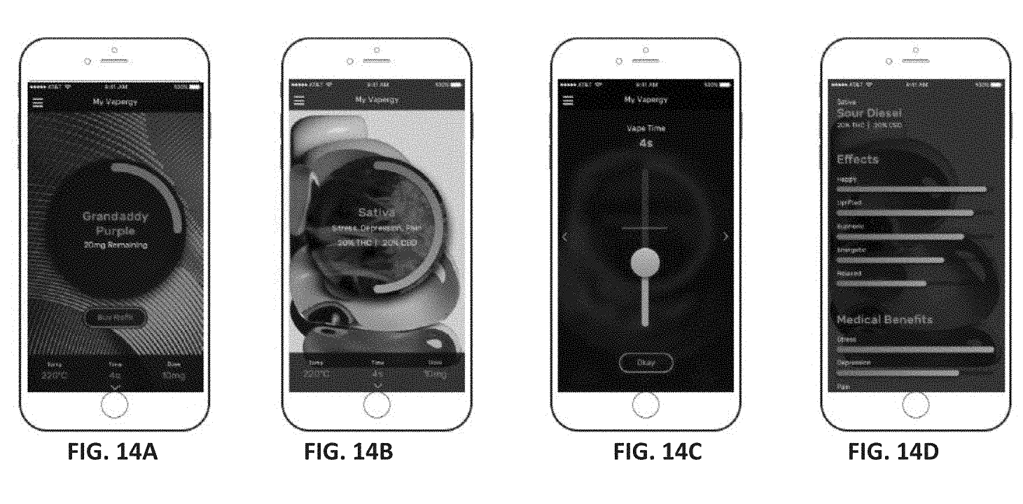

FIGS. 13A-14D illustrate various screenshots of a smart phone executing a smart phone application configured to control the vaping device shown in FIG. 12B according to an embodiment of the present disclosure.

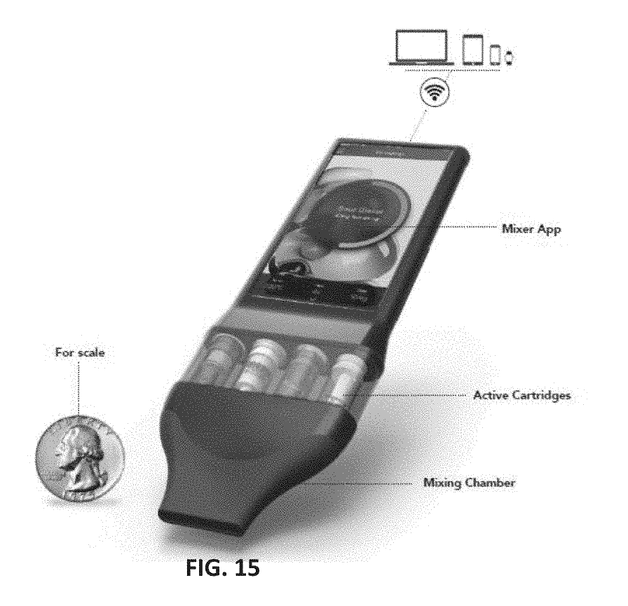

FIG. 15 illustrates a perspective view of a vaping device according to an embodiment of the present disclosure.

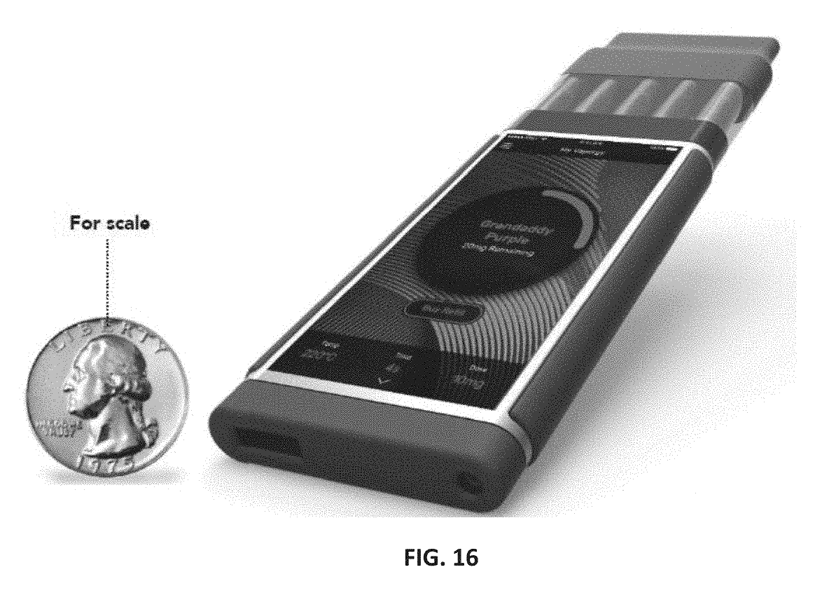

FIG. 16 illustrates a perspective view of a vaping device according to an embodiment of the present disclosure.

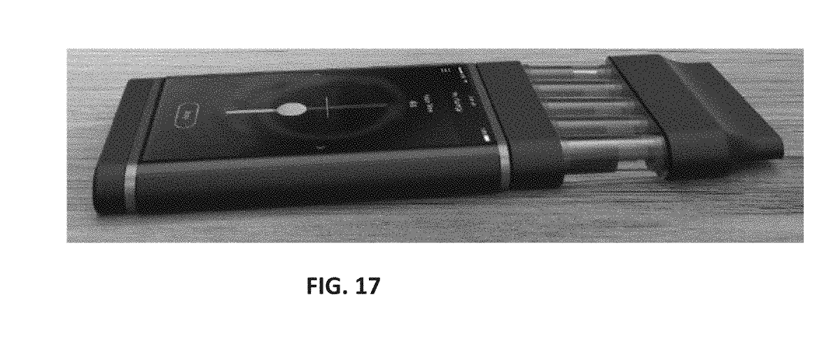

FIG. 17 illustrates a vaping device according to an embodiment of the present disclosure.

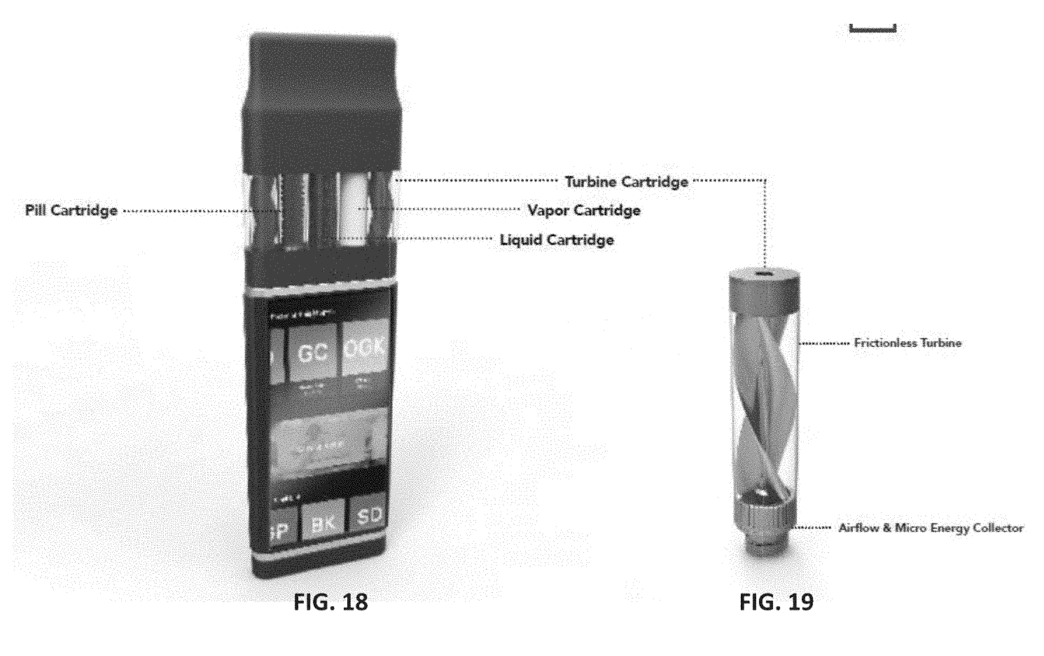

FIG. 18 illustrates a perspective view of a vaping device with different types of cartridges according to an embodiment of the present disclosure.

FIG. 19 illustrates a perspective view of an energy generating cartridge for the vaping device shown in FIG. 18 according to an embodiment of the present disclosure.

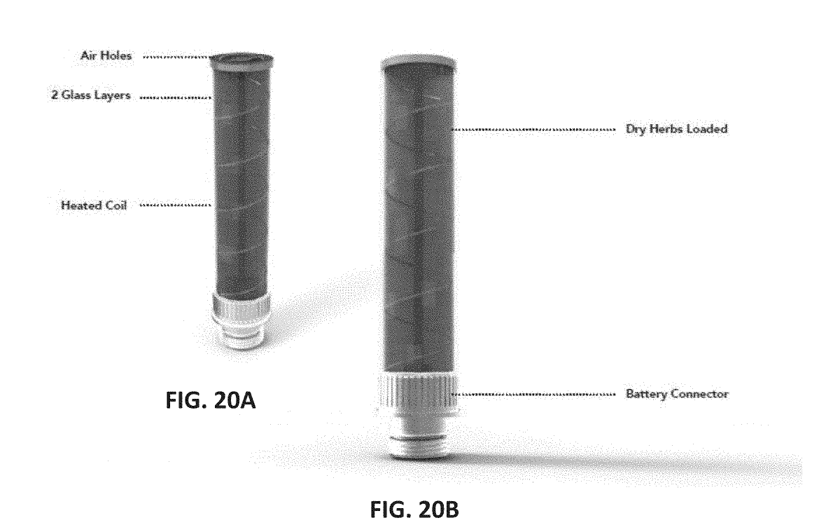

FIGS. 20A and 20B illustrate perspective views of a cartridge That can heat herbs for use in the vaping device shown in FIG. 18 according to an embodiment of the present disclosure.

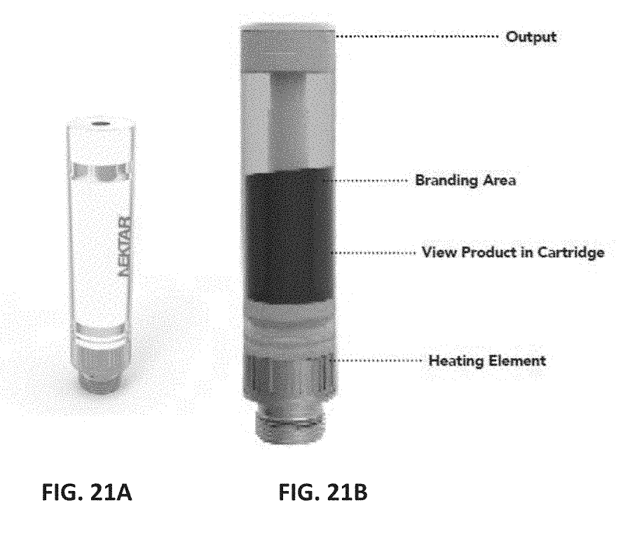

FIGS. 21A and 21B illustrate perspective views of cartridges that can heat oils or other liquids for use in the vaping device shown in FIG. 18 according to an embodiment of the present disclosure.

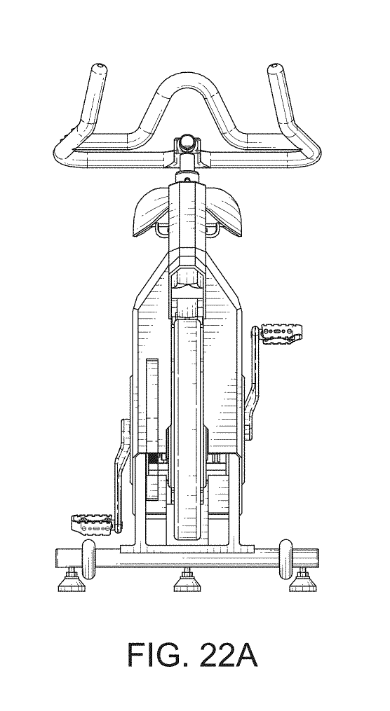

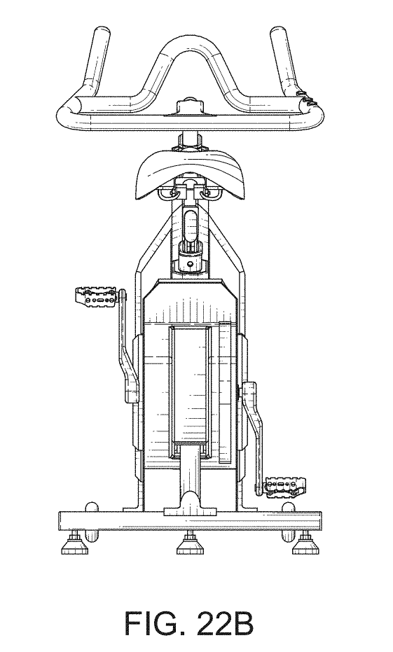

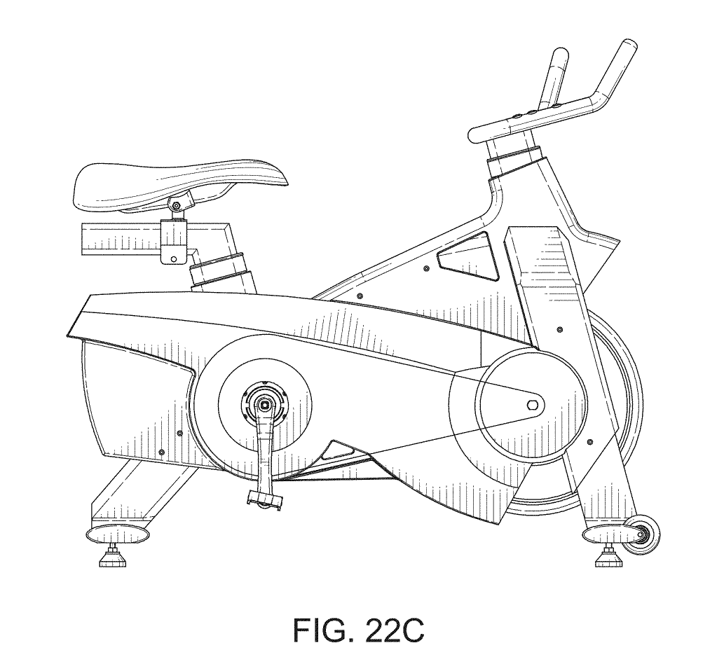

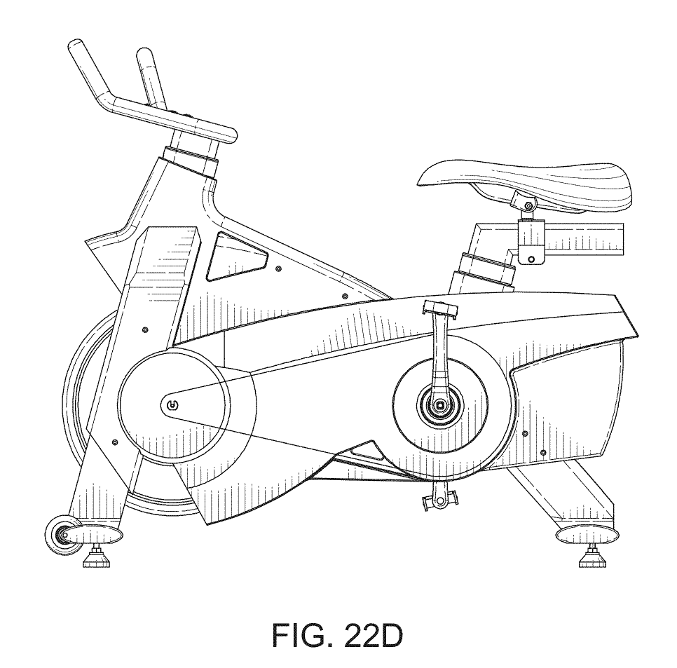

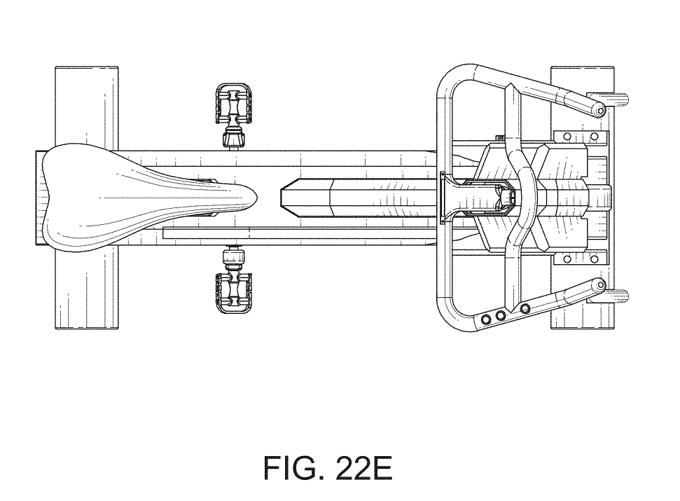

FIGS. 22A-22E illustrate various views of an exercise bicycle according to an embodiment of the present disclosure.

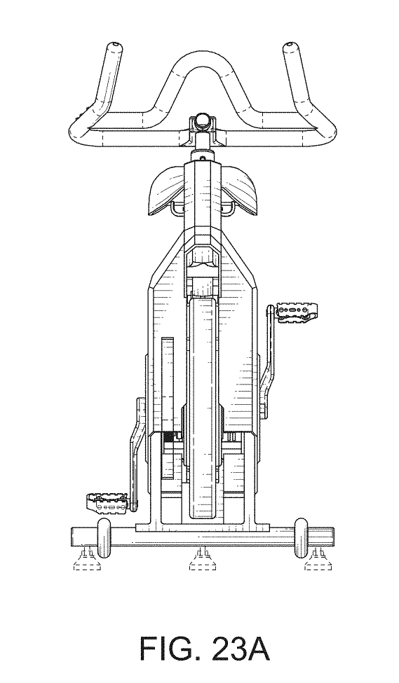

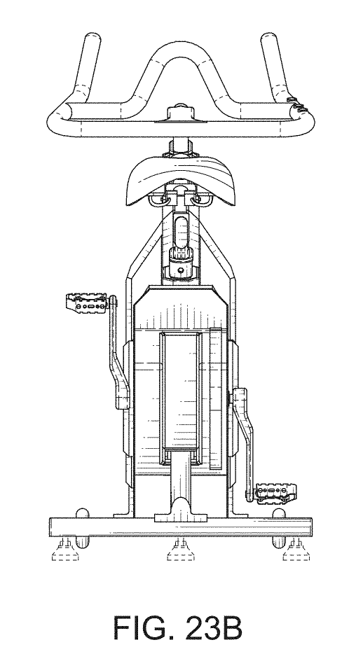

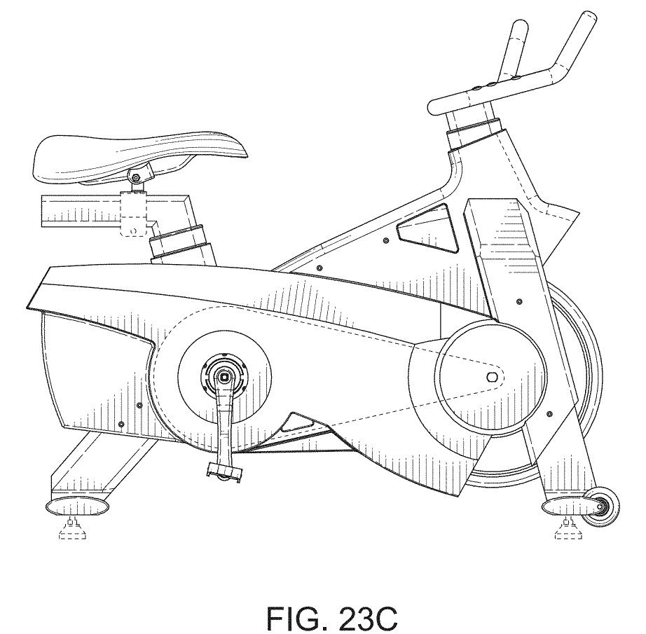

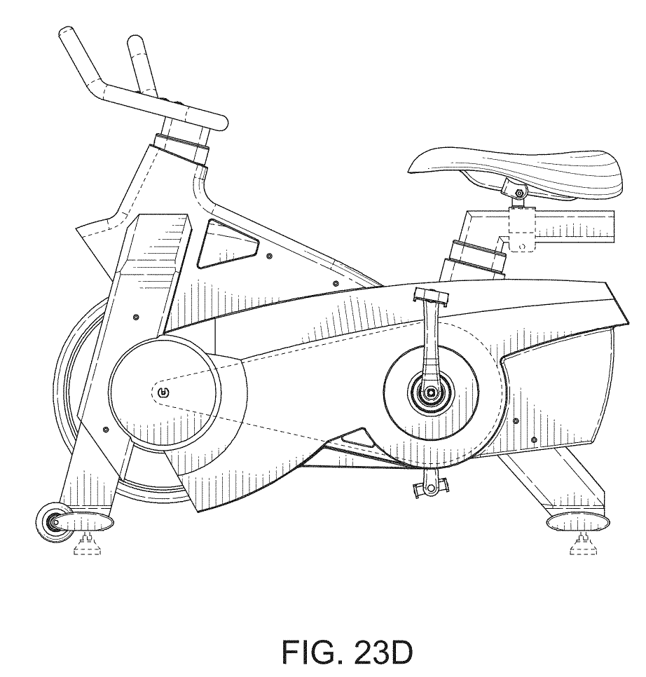

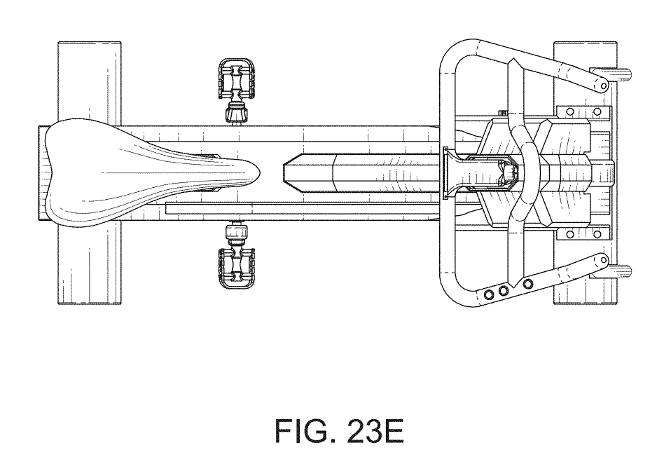

FIGS. 23A-23E illustrate various views of an exercise bicycle according to another embodiment of the present disclosure.

What is claimed is:

1. A portable charging system, comprising:
a central member including an electrical charge generating component and a plurality of communication ports; and
a plurality of peripheral members having a proximal end extending from the central member, each of the plurality of peripheral members including a communications interface configured to be inserted within a corresponding communications port of a computing device or a peripheral of a computing device;
wherein a first peripheral member of the plurality of peripheral members includes a USB port and a second peripheral member of the plurality of peripheral members includes a smartphone connector, and wherein the first peripheral member and the second peripheral member are communicatively and electrically coupled.

2. The portable charging system of claim 1, wherein the plurality of peripheral members includes a third peripheral member including an audio jack, the audio jack communicatively coupled to a computing device that is configured to be connected to the first peripheral member or the second peripheral member.
